(19) United States
(12) Patent Application Publication
(10) Pub. No.: US 2014/0267760 A1
(43) Pub. Date: Sep. 18, 2014

(54) ELECTRONIC DEVICE WITH CAMERA MODULE

(71) Applicant: Samsung Electronics Co., Ltd., Gyeonggi-do (KR)

(72) Inventors: Ki-Huk LEE, Gyeonggi-do (KR); Byung-Kwon KANG, Gyeonggi-do (KR); Jeong-Kil SHIN, Gyeonggi-do (KR); Sun-Hyoung PYO, Gyeonggi-do (KR)

(73) Assignee: Samsung Electronics Co., Ltd., Gyeonggi-do (KR)

(21) Appl. No.: 14/102,755

(22) Filed: Dec. 11, 2013

(30) Foreign Application Priority Data
Mar. 14, 2013 (KR) 10-2013-0027514

(51) Int. Cl. H04N 5/33; G02B 5/20

(52) U.S. Cl. CPC H04N 5/33; G02B 5/208
USPC 348/164

(57) ABSTRACT

An electronic device comprises a camera module comprising an infrared light filter for blocking infrared light and passing visible light. The infrared light filter comprises a filtering area, a peripheral area adjacent and peripheral to the filtering area and an opaque coating layer coating the infrared light filter in the peripheral area and blocking external light introduced into an image sensor and reducing flare artifacts.

### CLAIM OF PRIORITY

This application claims priority under 35 U.S.C. §119(a) to a Korean Patent Application filed in the Korean Intellectual Property Office on Mar. 14, 2013 and assigned Serial No. 10-2013-0027514, the contents of which are herein incorporated by reference.

### BACKGROUND

1. Technical Field

The present disclosure relates to an electronic device with a light filtering camera module.

2. Description of the Related Art

A lens flare phenomenon refers to a phenomenon in which, among light rays incident on an image sensor through a lens from a subject in a camera device, light rays reach a specific region of an upper surface of the image sensor due to an unexpected incidence path, thereby generating an unwanted pattern in a final video and causing a decrease of a photo contrast. Commonly, this lens flare phenomenon is conspicuous when a strong light source exists within an angle of view. This phenomenon can result from several causes.

### SUMMARY

An aspect of the present invention is to substantially address at least the above problems and/or disadvantages and to provide at least the advantages below. Accordingly, one aspect of the present invention is to provide an electronic device with a camera module for preventing a lens flare phenomenon of the camera module using different flare prevention methods associated with different flare causes. An electronic device with a camera module prevents a lens flare phenomenon using an existing filter, without a separate filtering means for preventing the lens flare phenomenon.

An electronic device comprises a camera module comprising an infrared light filter for blocking infrared light and passing visible light. The infrared light filter comprises a filtering area, a peripheral area adjacent and peripheral to the filtering area and an opaque coating layer coating the infrared light filter in the peripheral area and blocking external light introduced into an image sensor and reducing flare artifacts.

In a feature of the invention the infrared light filter is formed of glass material and the opaque coating layer is formed by printing black material. The opaque coating layer is external to a filter fixing area for fixing the infrared light filter to a camera assembly. Further, the opaque coating layer is disposed on either a first surface of the infrared light filter or a second surface facing the first surface. The opaque coating layers are disposed on both a first surface of the infrared light filter and a second surface facing the first surface and the opaque coating layer disposed on the first surface and the opaque coating layer disposed on the second surface do not overlap. The opaque coating layer is present in the whole peripheral area of the infrared light filter or in a partial area of the peripheral area of the infrared light filter. Further, in embodiments, the opaque coating layer completely or partially surrounds the filtering area of the infrared light filter. An area unoccupied by the opaque coating layer within the peripheral area comprises an area corresponding to an area exclusive of wiring of the image sensor or associated passive elements. Also an area occupied by the opaque coating layer within the peripheral area comprises an area overlapping with an area including wiring of the image sensor or associated passive elements.

In another feature, a camera module comprises an infrared light filter for blocking infrared light and passing visible light comprising: a filtering area; a peripheral area adjacent and peripheral to the filtering area; and an opaque coating layer coating the infrared light filter in the peripheral area and blocking external light introduced into an image sensor and reducing flare artifacts. The opaque coating layer is present in the whole or a partial peripheral area of the infrared light filter.

In another feature, a camera module (in an electronic device) comprises a housing comprising a lens housing; a lens assembly comprising a plurality of lenses which are housed in the lens housing; an infrared light filter disposed between the housing and the lens assembly; a cover attached to the housing; and an image sensor installed at an inner surface of the cover and disposed adjacent to the infrared light filter, wherein the infrared light filter comprises an opaque coating layer blocking external light introduced through the lens assembly, into an image and reducing flare artifacts.

In an additional feature, the infrared light filter comprises: a filtering area disposed in the middle of the infrared light filter; and a peripheral area disposed adjacent to the filtering area, wherein the opaque coating layer is disposed in the peripheral area of the infrared light filter. The opaque coating layer is disposed in all or part of the peripheral area of the infrared light filter.

### BRIEF DESCRIPTION OF THE DRAWINGS

The above features and advantages of the present invention will become more apparent from the following detailed description when taken in conjunction with the accompanying drawings in which:

FIG. 1 shows a front perspective view illustrating an electronic device with a camera module according to invention principles;

FIG. 2 shows a rear perspective view illustrating an electronic device according to invention principles;

FIG. 3 shows an exploded perspective view illustrating an assembled state of a camera module according to invention principles;

FIG. 4 shows a section illustrating an assembled state of a camera module according to invention principles;

FIG. 5 shows a perspective view illustrating a construction of an infrared cut-off filter provided in a camera module according to invention principles;

FIGS. 6A and 6B show an opaque coating layer applied to an infrared cut-off filter according to invention principles;

FIGS. 7A and 7B also show an opaque coating layer applied to an infrared cut-off filter according to invention principles;

FIG. 8 shows a further opaque coating layer applied to an infrared cut-off filter according to invention principles;

FIGS. 9A and 9B shows another opaque coating layer applied to an infrared cut-off filter according to invention principles;

FIG. 10 also shows an opaque coating layer applied to an infrared cut-off filter according to invention principles; and

FIG. 11 shows yet another opaque coating layer applied to an infrared cut-off filter according to invention principles.

### DETAILED DESCRIPTION

Preferred embodiments of the present invention will be described herein below with reference to the accompanying drawings. For the purposes of clarity and simplicity, well-known functions or constructions are not described in detail as they would obscure the invention in unnecessary detail.

In describing various exemplary embodiments of the present invention, an electronic device with one or more camera modules is described. Also, the electronic device can include a display module which can display image information shot by the camera module. An electronic device includes a touch screen as a display module and includes one or more camera modules but this is not intended to limit the scope of the present invention. For instance, the electronic device may be one of different devices with one or more camera modules, i.e., various devices such as a Personal Digital Assistant (PDA), a laptop computer, a mobile phone, a smart phone, a netbook, a Mobile Internet Device (MID), an Ultra Mobile Personal Computer (UMPC), a tablet PC, a navigator, an MPEG Audio Layer-3 (MP3) player, a general camera device, for example.

FIG. 1 shows a front perspective view illustrating an electronic device with a camera module, and FIG. 2 shows a rear perspective view illustrating an electronic device. Referring to FIG. 1 and FIG. 2, a display module 102 can be installed in front 101 of the electronic device 100. The display module 102 can be a touch screen which performs data input/output. A speaker module 103 can be installed above the display module 102, and a microphone 105 can be installed below the display module 102, supporting a voice call when the electronic device 100 is used as a communicating device. A plurality of sensors 104 can be provided at one side of the speaker module 103 facilitating use of the electronic device 100. The sensors 104 can be proximity sensors or illumination sensors but may include other different sensors. A camera module (C1) can be installed at one side of the sensors 104. The camera module (C1) can be disposed in front 101 of the electronic device 100 and performs a camera function or may be used for a video call. The other camera module (C2) can be installed in rear 106 of the electronic device 100. The camera modules (C1, C2) can take a still picture or a moving picture, or can output taken image information through the display module 102.

The camera modules (C1, C2) advantageously prevent a lens flare phenomenon that can result from a change of a refractive index occurring in a lens assembly, wiring included in an image sensor, reflection caused by a passive element, imperfect refraction caused by a sub-optimal lens assembly for example.

FIG. 3 shows an exploded perspective view illustrating an assembled state of a camera module. FIG. 4 shows a section illustrating an assembled state of a camera module. A camera module is denoted by ‘C1’ or ‘C2’ in FIG. 1 but is also referred to as ‘C’ below. Referring to FIG. 3 and FIG. 4, the camera module (C) can include a housing 10, a lens assembly 20, an infrared cut-off filter 30, an image sensor 40, and a cover 50. The housing 10 includes a lens housing 11. The lens assembly 20 includes a plurality of lenses 21, 22, 23, and 24 and is housed in the lens housing 11 of the housing 10. The infrared cut-off filter 30 is disposed between the lens assembly 20 and the housing 10. The image sensor 40 is disposed above the infrared cut-off filter 30. The cover 50 fixes the image sensor 40 and is coupled with the housing 10.

The housing 10 can include an opening 14 provided in a body 13 and introducing light from the external, the lens housing 11 for housing the lens assembly 20, the body 13 having the lens housing 11 in the middle thereof, and a frame 12 extending to have a predetermined height from the body 13. The frame 12 has an upper surface 121 which can be used as an attachment surface for attaching a peripheral area of the infrared cut-off filter 30. According to one exemplary embodiment, the housing 10 may be specified as a barrel. The infrared cut-off filter 30 can perform a function of filtering out infrared rays exclusive of visible rays from light introduced through the lens assembly 20. The infrared cut-off filter 30 can remove a wavelength of a near-infrared ray region in order to prevent the deterioration of definition and resolution of acquired video due to the image sensor 40 which senses not only a wavelength (400 nm to 700 nm) of a visible ray region but also the wavelength (˜1150 nm) of the near-infrared ray region. The infrared cut-off filter 30 can have a structure comprising two alternately deposited materials such as TiO₂ and SiO₂ or Ta₂O₅ and SiO₂ having different refractive indexes. The materials being deposited onto a glass substrate, i.e., a glass such as D263, thereby passing the visible ray region and reflecting the near-infrared ray region. An original filter (e.g., 127 mm×127 mm) is cut to a required size and is disposed to face the image sensor 40. The original filter is fabricated by determination of transmittance and reflection bands corresponding to desired wavelength bands and the presence of foreign surface materials greater than a predetermined size.

The image sensor 40 can be a Charge Coupled Device (CCD) or a Complementary Metal-Oxide Semiconductor (CMOS). According to one exemplary embodiment, the cover 50 can be assembled to cover the frame 12 of the housing 10, and the image sensor 40 can be fixed to an inner surface of the cover 50. The cover 50 can have an opening 51 in an area corresponding to an effective area of the image sensor 40. The infrared cut-off filter 30 can be attached to the upper surface 121 of the frame 12 of the housing 10 in which the lens assembly 20 is mounted. The infrared cut-off filter 30 can include an effective filtering area 31 and a peripheral area 32. The effective filtering area 31 is disposed in the middle of the infrared cut-off filter 30, and corresponds to the effective area 41 of the image sensor 40. The peripheral area 32 is disposed to surround the effective filtering area 31. In an embodiment, the effective filtering area 31 can be disposed in the interior of the peripheral area 32. The peripheral area 32 can include a filter fixing area 33 for attaching the infrared cut-off filter 30 to the upper surface 121 of the frame 12 of the housing 10. An opaque coating layer (‘BL’ in FIG. 5) is advantageously disposed in an area excluding the filter fixing area 33 from the peripheral area 32 preventing the lens flare phenomenon.

The image sensor 40 can include the effective area 41, and a sensor fixing area 42 disposed to surround the effective area 41 along an edge of the effective area 41. The image sensor 40 can be fixed to the cover 50 in a way that the sensor fixing area 42 is attached to an inner surface 52 of the cover 50. The camera module (C) can be assembled by ordered attachment of the housing 10 having the lens assembly 20, the infrared cut-off filter 30 and the cover 50 having the image sensor 40 fixed to the interior thereof. The opening 14 of the housing 10 of the assembled camera module (C), the effective area of the lens assembly 20, the effective filtering area 31 of the infrared cut-off filter 30, and the effective area 41 of the image sensor 40 are axially aligned. When the camera module (C) is assembled, the infrared cut-off filter 30 and the image sensor 40 are spaced apart at a predetermined interval. This separation space provides space for wiring 43 of the image sensor 40 or space for various passive elements (i.e., an inductor (L), a resistor (R), and a capacitor (C)), for example. The opaque coating layer (BL) can be applied to some or all of the peripheral area 32 of the infrared cut-off filter 30. The opaque coating layer (BL) prevents light introduced through the lens assembly 20 from being reflected and introduced into the image sensor 40 along an abnormal path.

FIG. 5 shows a perspective view illustrating a construction of an infrared cut-off filter provided in a camera. The effective filtering area 31 is disposed in the middle of the infrared cut-off filter 30 and passes a wavelength of a visible ray band among wavelengths of light introduced into the image sensor 40, thereby filtering out a wavelength of an infrared ray band. The peripheral area 32 is disposed adjacent to the effective filtering area 31 surrounding the effective filtering area 31. The opaque coating layer (BL) is disposed in the peripheral area 32 and comprises a black mask coating of one or more different known masking materials which are used for a shielding layer. The opaque coating layer (BL), black series comprises materials capable of efficiently cutting off an introduced light.

FIGS. 6A and 6B show an opaque coating layer applied to an infrared cut-off filter. The opaque coating layer (BL) can be disposed on an upper surface (US) of the peripheral area 32 of the infrared cut-off filter 30. The opaque coating layer (BL) can be disposed in an area excluding the filter fixing area 33. The filter fixing area 33 is an area corresponding to the upper surface (attachment surface) 121 of the frame 12 of the housing 10. That is because, if the opaque coating layer (BL) occupies the filter fixing area 33, an adhesive force or fixing force of the infrared cut-off filter 30 can be impaired. In an embodiment, the opaque coating layer (BL) is installed in a location overlapping with the wiring 43 of the image sensor 40 or associated passive elements.

FIGS. 7A and 7B show another opaque coating layer applied to an infrared cut-off filter. The opaque coating layer (BL) can be disposed on the peripheral area 32 of a lower surface (LS) of the infrared cut-off filter 30 and can be disposed extending up to the filter fixing area 33 corresponding to the upper surface (US). If no filter fixing area exists on the upper surface (US) or elsewhere, the opaque coating layer (BL) may be disposed throughout the peripheral area 32. FIG. 8 shows a further opaque coating layer applied to an infrared cut-off filter. FIGS. 9A and 9B also show an opaque coating layer applied to an infrared cut-off filter. Referring to FIG. 8, FIG. 9A and FIG. 9B, the opaque coating layer (BL) can be disposed in a partial area of the peripheral area 32 of the infrared cut-off filter 30. As illustrated in FIG. 8, the opaque coating layer (BL) can be disposed in a partial area of the peripheral area 32 of the upper surface (US) of the infrared cut-off filter 30.

FIG. 10 shows yet another opaque coating layer applied to an infrared cut-off filter. The opaque coating layer (BL) can be disposed in the peripheral area 32 of the infrared cut-off filter 30 partially surrounding the effective filtering area 31. For example, a portion where the opaque coating layer (BL) does not surround the effective filtering area 31 can be an area where the wiring 43 of the image sensor 40 or associated passive elements that are responsible for flare inducing reflection of light are not located. The opaque coating layer (BL) can be disposed on the upper surface (US) of the infrared cut-off filter 30 or on the lower surface (LS) of the infrared cut-off filter. The opaque coating layer (BL) partially surrounding the effective filtering area 31 of the infrared cut-off filter 30 can be applied to the embodiments FIGS. 6A and 6B to FIGS. 9A and 9B.

FIG. 11 shows an additional opaque coating layer applied to an infrared cut-off filter where opaque coating layers (BL1, BL2) may be disposed concurrently on the upper surface (US) of the infrared cut-off filter 30 and the lower surface (LS), respectively, partially or fully surrounding the effective filtering area 31 of the infrared cut-off filter 30. The opaque coating layers (BL1, BL2) disposed, partially or fully, both on the upper surface (US) of the infrared cut-off filter 30 and its lower surface (LS) can be applied to the cases of FIGS. 6A and 6B to FIGS. 9A and 9B. Projection areas of the opaque coating layers (BL1, BL2) of the infrared cut-off filter 30 may be disposed to fully or partially surround the effective filtering area 31. The camera module prevents a lens flare phenomenon without a separate lens-flare prevention filter, and overcomes constraints of the camera module.

While the invention has been shown and described with reference to certain preferred embodiments thereof, it will be understood by those skilled in the art that various changes in form and details may be made therein without departing from the spirit and scope of the invention as defined by the appended claims. The above-described embodiments can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. The functions and process steps herein may be performed automatically or wholly or partially in response to user command. An activity (including a step) performed automatically is performed in response to executable instruction or device operation without user direct initiation of the activity. No claim element herein is to be construed under the provisions of 35 U.S.C. 112, sixth paragraph, unless the element is expressly recited using the phrase “means for.”

What is claimed is:

1. An electronic device comprising
a camera module comprising an infrared light filter for blocking infrared light and passing visible light, the infrared light filter comprising:
a filtering area;
a peripheral area adjacent and peripheral to the filtering area; and
an opaque coating layer coating the infrared light filter in the peripheral area and blocking external light introduced into an image sensor and reducing flare artifacts.

2. The electronic device of claim 1, wherein the infrared light filter is formed of glass material.

3. The electronic device of claim 1, wherein the opaque coating layer is formed by printing black material.

4. The electronic device of claim 1, wherein the opaque coating layer is external to a filter fixing area for fixing the infrared light filter to a camera assembly.

5. The electronic device of claim 1, wherein the opaque coating layer is disposed on either a first surface of the infrared light filter or a second surface facing the first surface.

6. The electronic device of claim 1, wherein the opaque coating layers are disposed on both a first surface of the infrared light filter and a second surface facing the first surface.

7. The electronic device of claim 6, wherein the opaque coating layer disposed on the first surface and the opaque coating layer disposed on the second surface do not overlap.

8. The electronic device of claim 1, wherein the opaque coating layer is present in the whole peripheral area of the infrared light filter.

9. The electronic device of claim 1, wherein the opaque coating layer is present in a partial area of the peripheral area of the infrared light filter.

10. The electronic device of claim 1, wherein the opaque coating layer completely surrounds the filtering area of the infrared light filter.

11. The electronic device of claim 1, wherein the opaque coating layer partially surrounds the filtering area of the infrared light filter.

12. The electronic device of claim 11, wherein an area unoccupied by the opaque coating layer within the peripheral area comprises an area corresponding to an area exclusive of wiring of the image sensor or associated passive elements.

13. The electronic device of claim 1, wherein an area occupied by the opaque coating layer within the peripheral area comprises an area overlapping with an area including wiring of the image sensor or associated passive elements.

14. A camera module comprising
an infrared light filter for blocking infrared light and passing visible light comprising:
a filtering area;
a peripheral area adjacent and peripheral to the filtering area; and
an opaque coating layer coating the infrared light filter in the peripheral area and blocking external light introduced into an image sensor and reducing flare artifacts.

15. The camera module of claim 14, wherein the opaque coating layer is present in the whole peripheral area of the infrared light filter.

16. The camera module of claim 14, wherein the opaque coating layer is present in a partial area of the peripheral area of the infrared light filter.

17. A camera module comprising:
a housing comprising a lens housing;
a lens assembly comprising a plurality of lenses which are housed in the lens housing;
an infrared light filter disposed between the housing and the lens assembly;
a cover attached to the housing; and
an image sensor installed at an inner surface of the cover and disposed adjacent to the infrared light filter,
wherein the infrared light filter comprises an opaque coating layer blocking external light introduced through the lens assembly, into an image and reducing flare artifacts.

18. The camera module of claim 17, wherein the infrared light filter comprises:
a filtering area disposed in the middle of the infrared light filter; and
a peripheral area disposed adjacent to the filtering area,
wherein the opaque coating layer is disposed in the peripheral area of the infrared light filter.

19. The camera module of claim 17, wherein the opaque coating layer is disposed in all or part of the peripheral area of the infrared light filter.

20. An electronic device comprising a camera module of claim 17.
